(19) United States
(12) Patent Application Publication
(10) Pub. No.: US 2018/0094471 A1
(43) Pub. Date: Apr. 5, 2018

(54) VEHICLE WINDOW WITH GESTURE CONTROL

(71) Applicant: MAGNA MIRRORS OF AMERICA, INC., Holland, MI (US)

(72) Inventor: J.R. Scott Mitchell, Newmarket (CA)

(21) Appl. No.: 15/722,146

(22) Filed: Oct. 2, 2017

Related U.S. Application Data
(60) Provisional application No. 62/403,457, filed on Oct. 3, 2016.

(51) Int. Cl. E05F 15/643

(52) U.S. Cl. CPC E05F 15/643; E05Y 2900/55

(57) ABSTRACT

A slider window assembly for a vehicle includes a frame portion, at least one fixed window panel that is fixed relative to the frame portion, and a movable window panel that is movable along upper and lower rails of the frame portion between a closed position and an opened position. A gesture sensing device is operable to sense a gesture of a user in the vehicle and to determine if the sensed gesture is indicative of an open window command or a close window command. A drive system is operable to move the movable window between the opened position and the closed position. The drive system moves the movable window panel responsive to the gesture sensing device determining that a sensed gesture is indicative of an open window command or a close window command.

### CROSS REFERENCE TO RELATED APPLICATION

The present application claims the filing benefits of U.S. provisional application Ser. No. 62/403,457, filed Oct. 3, 2016, which is hereby incorporated herein by reference in its entirety.

### FIELD OF THE INVENTION

The present invention relates to a slider window assembly for a vehicle and, more particularly, a rear slider window assembly for a vehicle and, more particularly, a rear slider window assembly for a pickup truck or the like.

### BACKGROUND OF THE INVENTION

It is known to provide a slider window assembly for an opening of a vehicle, such as a rear slider window assembly for a rear opening of a pickup truck. Conventional slider window assemblies for rear openings of trucks or the like typically include three or more panels, such as two fixed window panels and a slidable window panel. The slidable window panel is supported by rails and may be moved along the rails to open and close the window. The slidable window panel may be driven or moved by a cable drive system, such as described in U.S. Pat. No. 8,151,519, which is hereby incorporated herein by reference in its entirety. The cable drive system is operable via a user in the vehicle actuating a switch or button to actuate the cable drive system to move the window panel in the desired direction to open or close the window.

### SUMMARY OF THE INVENTION

The present invention provides a rear slider window assembly that is opened and closed via a drive system that is operable in response to a gesture sensing device in the vehicle cabin. The gesture sensing device is operable to sense a gesture of a user in the vehicle and to determine if the sensed gesture is indicative of an open window command or a close window command. A drive system is operable to move the movable window between its opened and closed positions, and moves the movable window panel responsive to the gesture sensing device determining that a sensed gesture is indicative of an open window command or a close window command.

These and other objects, advantages, purposes and features of the present invention will become apparent upon review of the following specification in conjunction with the drawings.

### BRIEF DESCRIPTION OF THE DRAWINGS

FIG. 1 is a rear perspective view of a pickup truck having a rear slider window assembly in accordance with the present invention, showing the window panel closed;

FIG. 2 is another rear perspective view of the pickup truck, showing the window panel moved to its open position;

FIG. 3 is a perspective view of a window assembly having a cable drive system, which is operable responsive to a touch or proximity or gesture sensor in the vehicle cabin;

FIG. 4 is a perspective view of a sensing device operable to sense touch or proximity of a person's finger or hand;

FIG. 5 is another view of the sensing device of FIG. 4, shown with a user's hand moving left or right to close or open the rear slider window;

FIG. 6 is a sectional view of the sensing device taken along the line VI-VI in FIG. 5;

FIG. 7 is a perspective view of the printed circuit board of the sensing device;

FIG. 8 is a top plan view of the circuit board of FIG. 7;

FIG. 9 is a side view of the circuit board of FIG. 7; and

FIG. 10 is a bottom plan view of the circuit board of FIG. 7.

### DESCRIPTION OF THE PREFERRED EMBODIMENTS

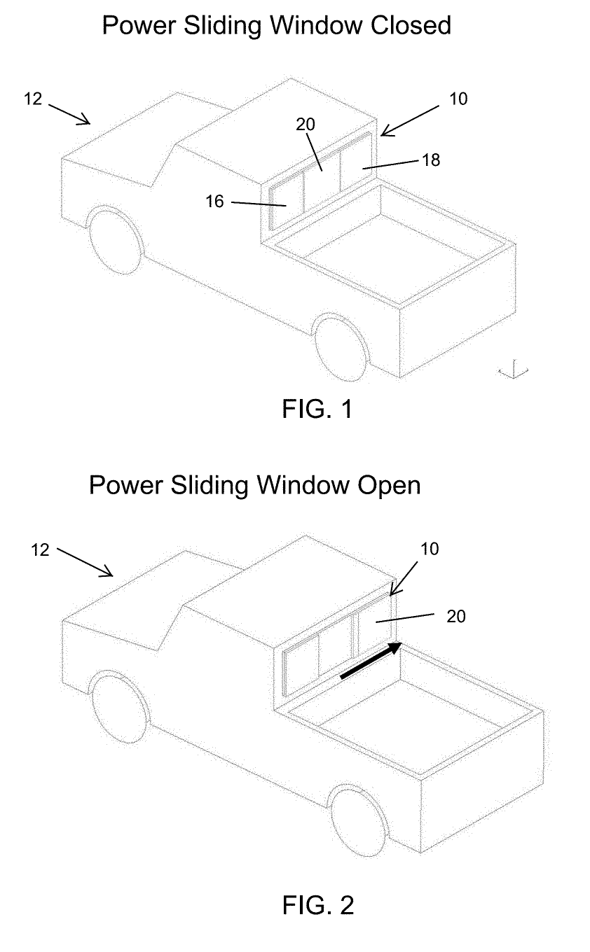

Referring now to the drawings and the illustrative embodiments depicted therein, a rear slider window assembly 10 of a vehicle 12 (such as a pickup truck or the like) includes a pair of side fixed window panels 16, 18 and a movable window panel 20 that is movable relative to a frame 14 and fixed window panels 16, 18 between an opened position and a closed position (FIGS. 1-3). The frame 14 comprises an upper rail 22 and a lower rail 24, with the upper and lower edge regions of movable window panel 20 movably or slidably received in and along the respective upper and lower rails 22, 24. Lower rail 24 comprises an elongated generally U-shaped channel portion disposed generally horizontally along the rear slider window and spanning at least part of each of the fixed window panels 16, 18. The lower edge region of the movable window panel 20 is received in or attached to a carrier, which is movably received in channel portion of the lower rail 24 and is movable or slidable along channel portion as the movable window panel 20 is moved between its opened and closed positions via operation of a cable drive system 26. The cable drive system 26 is operable responsive to a gesture sensing device 28 disposed in the vehicle, where the gesture sensing device senses movement of a user's hand and determines when the movement is indicative of a gesture to open or close the movable window panel 20, as discussed below.

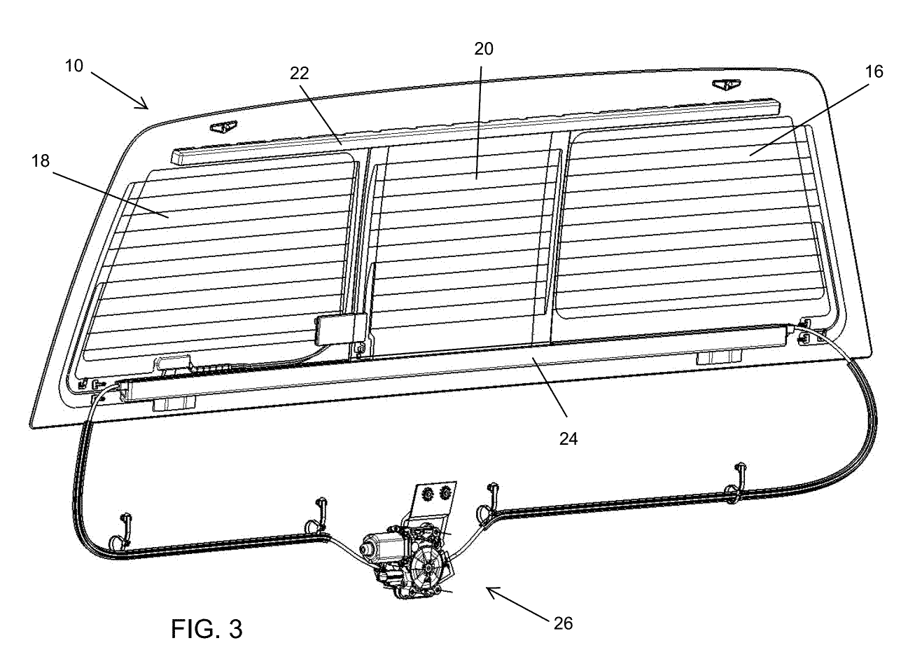

In the illustrated embodiment of FIGS. 1 and 2, window assembly 10 includes two fixed window panels or panel portions 16, 18 that are spaced apart so as to define an opening therebetween. The fixed window panels may comprise two separate spaced apart fixed window panels that define the opening therebetween (and with upper and lower appliqués or trim or filler panels or elements disposed at the upper and lower regions of the opening and between the fixed window panels), while remaining within the spirit and scope of the present invention. Optionally, and such as shown in FIG. 3, the window assembly may comprise a hole-in-glass window configuration, where a single fixed glass panel has an aperture or hole or opening established therethrough to define separate spaced apart fixed window panels or panel portions, such as in a similar manner as the window assemblies described in U.S. Pat. No. 8,881,458, which is hereby incorporated herein by reference in its entirety.

Slider or movable window panel 20 is movable along lower rail 24 and upper rail 22 of frame portion 14 to open and close the aperture or opening, such as in a manner similar to known slider window assemblies. The movable or slider window panel 20 may be movable such as via manual pushing or pulling at the window panel and preferably is movable in response to actuation of a drive motor 26a of the drive motor assembly or system 26, which may move cables or wires of cable assemblies relative to the sheath of the cable assemblies to impart horizontal movement of the carrier and slider window panel 20 along the rails 22, 24. The cable sheath and cable or wire are routed through and/or retained at cable guides that are disposed at the end regions of the channel portion of the lower rail 24. Optionally, the drive motor assembly 26a and system 26 may utilize aspects of the drive assemblies of the types described in U.S. Pat. Nos. 8,938,914; 4,920,698; 4,995,195; 5,146,712; 5,531,046; 5,572,376; 6,955,009 and/or 7,073,293, and/or U.S. Publication Nos. US-2004-0020131 and/or US-2008-0127563, which are all hereby incorporated herein by reference in their entireties.

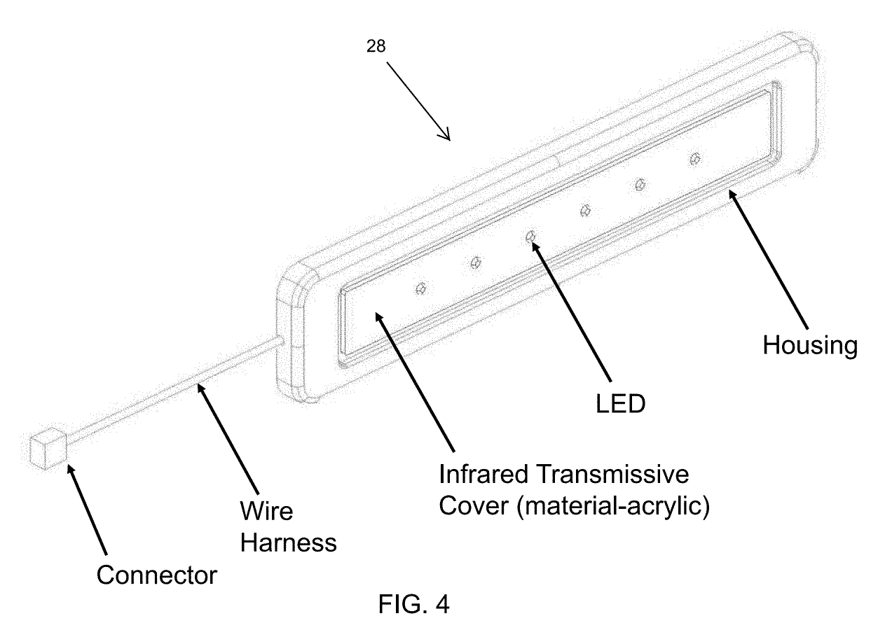

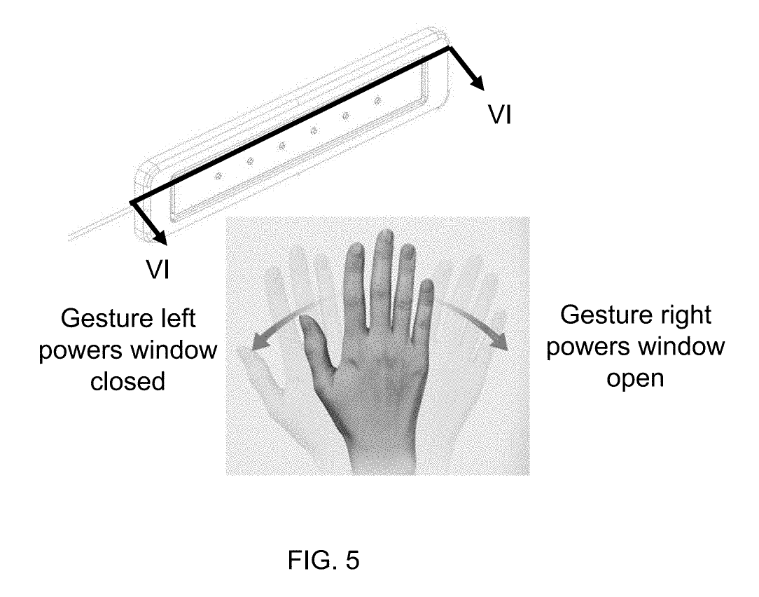

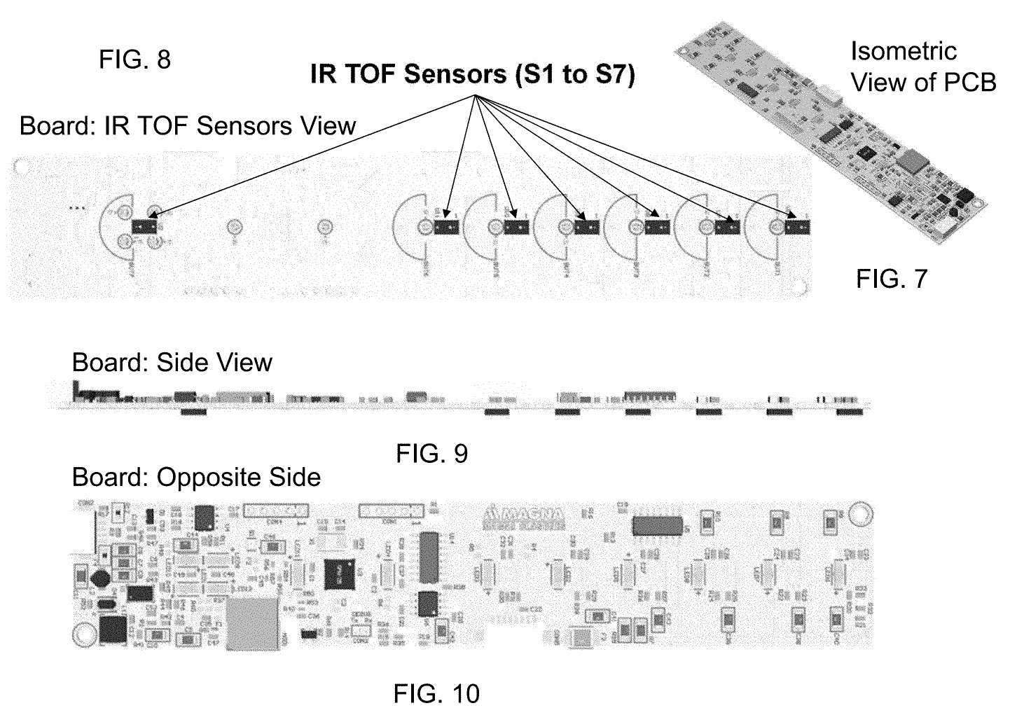

Thus, the movable window panel is movable along the upper and lower channels or rails between its opened and closed positions via a motorized drive system 26, which is operable responsive to a gesture sensing device 28 (FIGS. 4-10). The gesture sensing device may be disposed anywhere in the cabin of the vehicle where a driver or passenger can readily access the sensing area at or near the sensing device. For example, the sensor assembly may be packaged in a rearview mirror of the vehicle, or at the dashboard of the vehicle or at an interior portion of the rear sliding window assembly (where the sensing device and system may be incorporated into the window assembly so as to avoid additional wiring and the like to position the sensing device remote from the window assembly).

The gesture sensing device 28 may comprise any suitable sensing device, such as an infrared (IR) time of flight (TOF) gesture/keypad touch detection device. Optionally, the sensors may comprise any suitable sensors, such as TOF sensors or radar sensors or ultrasonic sensors or infrared sensors or capacitive sensors and/or the like. The device and system (and algorithm associated therewith) may determine when a user's hand or finger is at a predetermined distance from the sensor. For example, the system may determine when the user's hand is in a “gesture zone”, which is a sensor measured distance value between 31 mm and 255 mm, whereby the movement of the hand in the gesture zone is considered a gesture. For example, the system may determine when the user's hand is in a “touch zone”, which is a sensor measured distance value between 0 mm and 30 mm, whereby the movement of the hand in the gesture zone is considered a touch. The gesture task and the touch task are run in parallel to each other. Thus, the system may operate differently depending on the proximity of or distance to the sensed object. For example, if the object is determined to be within the gesture zone, the system senses the movement and determines whether or not the object movement is indicative of an “open window” or “close window” command, but if the object is determined to be within the touch zone, the system determines if the object is at a particular touch region or input region of the sensing device, and if the object is outside of the gesture zone (e.g., more than 255 mm from the sensor), then the system ignores the object.

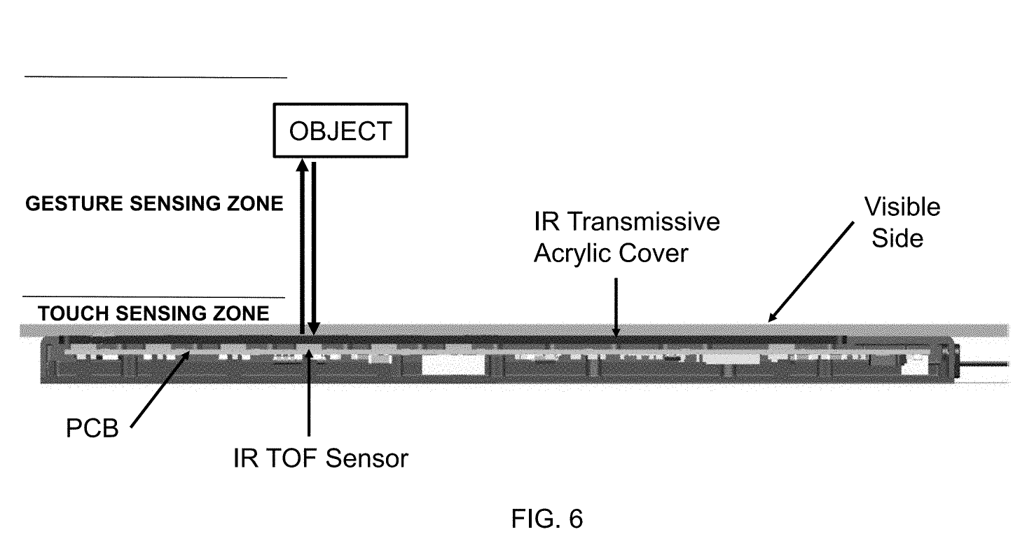

In the illustrated embodiment, the sensing device 28 includes a plurality of IR TOF sensors (see FIGS. 6 and 8), which may be polled via an I2C bus every 1 millisecond or thereabouts to determine if an object is within the sensing ranges or zones. The system operates with a gesture detection methodology, which starts by flagging the start of a gesture movement when either the top-most (or left-most or right-most) sensor or bottom-most (or left-most or right-most) sensor detects an object in the gesture zone, and no other sensor detects an object closer than the start sensor. If the top-most sensor (or, for example, a right-most sensor) detects an object first, then the start of a downward swipe (or right to left swipe) is flagged (such as to close the window). If the bottom-most sensor (or, for example, a left-most sensor) detects an object first, then the start of an upward swipe (or left to right swipe) is flagged (such as to open the window).

The system then anticipates that the next sensor in the direction that was flagged to be active. This sensor is considered active if (i) it is in the gesture zone, (ii) no other sensor except those previously flagged reports an object closer than this sensor (if this condition is not met, the gesture sequence is reset), (iii) no previously flagged sensor indicates a touch (if this condition is not met, the gesture sequence is reset), and (iv) activity is seen before timing out (which may occur following a predetermined period of time, such as 20 milliseconds, for example). The previous step (anticipating the next sensor that will sense the user's hand and sensing the user's hand at or near that sensor) is repeated until the final sensor (e.g., the right-most sensor if the left-most sensor is the first sensor that determines the presence of the user's hand) is processed successfully. At this point a successful upward or downward or leftward or rightward gesture is reported.

The determination of whether the gesture is a start of an open or close command for the window may also be responsive to an initial determination of the state of the window. For example, if the system determines that the sensed gesture is the start of an “open window” command, but the window is already open, then the system will not consider the sensed gesture to be an open window command. Similarly, if the system determines that the sensed gesture is the start of a “close window” command, but the window is already closed, then the system will not consider the sensed gesture to be a close window command.

Optionally, an additional sensor may also be added to detect an obstacle in the path of the door to provide non-contact obstacle detection (NCOD). The additional sensor can be orientated normal to the path of the window near the window close position, and thus may be positioned to sense a possible pinch situation right before anything gets pinched. Optionally, an array of sensors could be used as a “light curtain” to sense the entire opening to determine presence of an object or item or person's hand anywhere in the opening where the movable window panel may contact when being closed. Optionally, the sensor or array of sensors may also sense the area that the movable window panel moves to when opening so as to sense presence of an object at the fixed window panel and in the path of travel of the movable window panel when moving toward the opened position. The system thus may open or close the window responsive to detection of a gesture by the gesture sensing device, but if an object is detected to be present in the path of travel of the movable window panel, the system or control device may stop or prevent movement (or may even reverse direction) of the movable window panel irrespective of detection of a gesture by the gesture sensing device.

Thus, the sensing system and window opening/closing system of the present invention is operable to determine when a user's hand is within a particular range or zone relative to the sensing device and then to determine whether the hand moves in a manner that is to be indicative of a window open gesture or a window close gesture. For example, if a user wants to open the window, the user may position his or her hand at or near a left end of the sensing device or strip and may move the hand to the right, whereby the system detects the initial position of the hand and determines that the hand is within the “gesture zone” and then determines the further movement of the hand along the sensing device in the direction of an “open window” command. Responsive to such a determination (and a further determination that the window is not already fully opened), the system may actuate the cable drive system to open the window. Similarly, if a user wants to close the window, the user may position his or her hand at or near a right end of the sensing device or strip and may move the hand to the left, whereby the system detects the initial position of the hand and determines that the hand is within the “gesture zone” and then determines the further movement of the hand along the sensing device in the direction of a “close window” command. Responsive to such a determination (and a further determination that the window is not already fully closed), the system may actuate the cable drive system to close the window. Optionally, if the user stops movement of the hand mid-way or partially along the sensing device, the system may operate to only partially open or close the window to allow the user to partially open or partially close the window.

Optionally, and desirably, the window assembly and system may include an anti-pinch feature or functionality, which stops the closing (or opening) of the window panel if the panel encounters an object in its path (such as if a person's hand is in the way and may get pinched if the window does not stop). This may be important as the determined gesture is not a supervised action—it is a momentary input. If a traditional power slider requires that a switch or button be held down to “supervise” the action, then if something gets pinched it is the operator's responsibility because the operator watched the event (and the operator can readily stop the action by releasing the button). However, once the gesture input is received by the gesture sensing and control system, the operator no longer requires to “hold a button down” or provide any other inputs, and the system has been commanded to execute a close or open and will continue until something indicates it to stop, which is likely the end of travel of the window to its fully opened or fully closed position. However, if an object is put into the path of the movable window, anti-pinch functionality would limit the forces on that object. Although not critical to the function of the sensor or sensing device and how it operates, such a function is desirable for the window control to avoid harm to a person who may have their hand or finger in the path of the opening or closing window panel. The control system may be responsive to stop movement of the window panel when a degree of resistance of travel of the movable window panel exceeds a threshold level or when a load on the drive motor exceeds a threshold load or the like.

The sensing device thus may determine a gesture or hand movement in a left or right direction and may close or open the window accordingly. Optionally, it is envisioned that the sensing system and control system may be suitable for use on vertically movable windows (such as the types described in U.S. Publication No. US-2016-0167488, which is hereby incorporated herein by reference in its entirety), where the sensing device may be vertically oriented and sense upward or downward gestures and may close or open the window accordingly. Optionally, the window assembly may comprise a dual movable window panel system (such as the types described in U.S. patent application Ser. No. 15/617,215, filed Jun. 8, 2017 (Attorney Docket DON02 P-3050), which is hereby incorporated herein by reference in its entirety), where the sensing device may be horizontally oriented and sense leftward or rightward gestures and may close or open the window accordingly (the swipe direction for opening or closing the window may vary depending on the particular application).

Optionally, and such as shown in FIG. 3, the fixed window panels 16, 18 each include an electrically conductive heater grid or other heating element or electrically operable element established at the window panels (such as at or on an interior surface of the window panels) and movable window panel 20 includes an electrically conductive heater grid or other heating element or electrically operable element established at the window panel (such as at or on an interior surface of the movable window panel). The heater grids are electrically conductively connected to (or are otherwise in electrical conductive continuity with) a power source of the vehicle and may be powered (such as responsive to a user actuatable input or switch or button (or touch or gesture sensing device as discussed above) of the vehicle or responsive to a sensor or accessory of the vehicle) to heat or defrost or defog the fixed window panels 16, 18. The movable panel heater grid is electrically connected to the power source (and may be electrically connected to electrical terminals or elements at one of the heater grids of the fixed window panels) and may be electrically powered to heat or defrost or defog the movable window panel 20. The heater grids comprise a plurality of electrically conductive traces that extend across the respective window panels 16, 18, 20 between respective busbars to provide enhanced and more uniform heating and defrosting/defogging of the window panel, as also discussed below. The heater grid of movable window panel 20 may be powered in a manner that allows for heating or defogging or defrosting of the movable window panel irrespective of whether the movable window panel is opened or partially opened or closed. For example, the electrical connections may be made via a flexible connector or wire or cable or the like, such as by utilizing aspects of the rear slider window assemblies described in U.S. Pat. Nos. 8,938,914; 8,881,458 and/or 8,402,695, which are hereby incorporated herein by reference in their entireties. Optionally, the heater grid of the movable window panel may be powered only when in its closed position and/or via any suitable powering means.

The benefits of embodiments of the present invention may also be realized in sliding window constructions where an aperture is created in a fixed window panel and where a movable window panel can be made to open or close the aperture. Slider windows of this type are disclosed such as in U.S. Pat. Nos. 8,915,018 and/or 8,881,458, and/or U.S. Publication No. US-2003-0213179, and/or such as in RE41502, which are hereby incorporated herein by reference in their entireties. The benefits of embodiments of the present invention may also be realized in vehicular movable window assemblies other than a rear slider window assembly for a pickup truck or the like, such as (for example) a slider window assembly suitable for use as a movable side window for a vehicle such as a van or a bus.

Optionally, the window assembly or assemblies of the present invention may utilize aspects of the window assemblies described in U.S. Pat. Nos. 8,915,018; 8,881,458; 8,402,695; 7,073,293; 7,003,916; 6,119,401; 6,026,611; 5,996,284; 5,799,444 and/or 6,691,464, and/or U.S. Publication Nos. US-2014-0047772; US-2006-0107600; US-2008-0127563; US-2004-0020131 and/or US-2003-0213179, all of which are hereby incorporated herein by reference in their entireties.

Changes and modifications to the specifically described embodiments may be carried out without departing from the principles of the present invention, which is intended to be limited only by the scope of the appended claims, as interpreted according to the principles of patent law.

1. A slider window assembly for a vehicle, said slider window assembly comprising:
a frame portion having an upper rail and a lower rail;
at least one fixed window panel that is fixed relative to said frame portion, said at least one fixed window panel defining an opening;
a movable window panel that is movable along said upper rail and said lower rail, wherein said movable window panel is movable between a closed position, where said movable window panel is disposed at said opening, and an opened position, where said movable window panel is disposed at least partially along said first fixed window panel;
a gesture sensing device operable to sense a gesture of a user in the vehicle and to determine if the sensed gesture is indicative of an open window command or a close window command; and
a drive system operable to move the movable window between the opened position and the closed position, wherein said drive system moves the movable window panel responsive to said gesture sensing device determining that a sensed gesture is indicative of an open window command or a close window command.

2. The slider window assembly of claim 1, wherein said gesture sensing device comprises a plurality of time of flight sensors disposed linearly along a circuit board.

3. The slider window assembly of claim 1, wherein said gesture sensing device comprises a plurality of sensors disposed linearly along a circuit board.

4. The slider window assembly of claim 1, wherein said gesture sensing device senses an initial location of an object and determines if the sensed object is in a gesture zone.

5. The slider window assembly of claim 4, wherein, responsive to determination that the sensed object is in the gesture zone, said gesture sensing device senses movement of the object and determines if the movement of the object is indicative of an open window command or a close window command.

6. The slider window assembly of claim 5, wherein the gesture zone is an area more than about 30 mm from said gesture sensing device and less than about 250 mm from said gesture sensing device.

7. The slider window assembly of claim 1, wherein said gesture sensing device senses whether or not an object is in the path of travel of said movable window panel and stops or prevents movement of said movable window panel irrespective of a sensed gesture.

8. The slider window assembly of claim 1, comprising an object sensing device that senses whether or not an object is in the path of travel of said movable window panel and wherein, responsive to determination of an object in the path of travel of said movable window assembly, said drive system stops or prevents movement of said movable window panel irrespective of a gesture sensed by said gesture sensing device.

9. The slider window assembly of claim 1, wherein said drive system is operable responsive to a determination of a current state of said movable window panel.

10. The slider window assembly of claim 1, wherein said drive system comprises a cable drive system, and wherein cables of said cable drive system are guided by cable guides disposed at opposite ends of a channel portion of said lower rail.

11. The slider window assembly of claim 1, wherein said at least one fixed window panel comprises first and second fixed window panels defining an opening therebetween.

12. The slider window assembly of claim 1, wherein said at least one fixed window panel comprises a single fixed window panel having an opening therethrough.

13. A slider window system for a vehicle, said slider window system comprising:
a slider window assembly comprising a frame portion having an upper rail and a lower rail;
wherein said slider window assembly comprises at least one fixed window panel that is fixed relative to said frame portion, said at least one fixed window panel defining an opening;
wherein said slider window assembly comprises a movable window panel that is movable along said upper rail and said lower rail, wherein said movable window panel is movable between a closed position, where said movable window panel is disposed at said opening, and an opened position, where said movable window panel is disposed at least partially along said first fixed window panel;
a gesture sensing device having a field of sensing within a cabin of the vehicle, wherein said gesture sensing device is operable to sense a gesture of a user in the field of sensing of said gesture sensing device and to determine if the sensed gesture is indicative of an open window command or a close window command;
an object sensing device having a field of sensing at said movable window panel so as to detect presence of an object in a path of travel of said movable window panel toward the opened position or the closed position;
wherein said slider window assembly comprises a drive system operable to move the movable window between the opened position and the closed position, wherein said drive system moves the movable window panel toward the opened position responsive to said gesture sensing device determining that a sensed gesture is indicative of an open window command or moves the movable window panel toward the closed position responsive to said gesture sensing device determining that a sensed gesture is indicative of a close window command; and
wherein, responsive to detection of an object in the path of travel of said movable window panel, said drive system stops or limits movement of said movable window panel toward the opened position or the closed position irrespective of determination that a sensed gesture is indicative of a respective open window command or close window command.

14. The slider window system of claim 13, wherein said gesture sensing device comprises a plurality of time of flight sensors disposed linearly along a circuit board.

15. The slider window system of claim 13, wherein said gesture sensing device comprises a plurality of sensors disposed linearly along a circuit board.

16. The slider window system of claim 13, wherein said gesture sensing device senses an initial location of an object and determines if the sensed object is in a gesture zone, and wherein, responsive to determination that the sensed object is in the gesture zone, said gesture sensing device senses movement of the object and determines if the movement of the object is indicative of an open window command or a close window command.

17. The slider window system of claim 13, wherein said drive system is operable responsive to a determination of a current state of said movable window panel.

18. The slider window system of claim 13, wherein said gesture sensing device is part of said slider window assembly and is disposed at an interior portion of said slider window assembly.

19. The slider window system of claim 13, wherein said object sensing device is part of said slider window assembly.

20. The slider window system of claim 13, wherein said object sensing device comprises an array of sensors that sense the opening to determine presence of an object at the opening.
